(19) United States
(12) Patent Application Publication
(10) Pub. No.: US 2019/0389390 A1
(43) Pub. Date: Dec. 26, 2019

(54) MOBILE TERMINAL PROTECTIVE BUMPER

(71) Applicant: HUIZHOU CHINFAI ELECTRONIC CO., LTD

(72) Inventor: Li Zanxiang, Shenzhen (CN)

(21) Appl. No.: 16/375,042

(22) Filed: Apr. 4, 2019

(30) Foreign Application Priority Data
Jun. 22, 2018 (CN) 201830323975.7

(51) Int. Cl. B60R 7/08; B60R 7/04; B60R 11/00

(52) U.S. Cl. CPC B60R 7/08; B60R 2011/0017; B60R 11/00; B60R 7/043

(57) ABSTRACT

A protective case for digital products, including a protective bumper body, wherein the protective bumper body includes a holding slot for receiving a mobile terminal, a first arm positioned on a first side of the protective bumper body, wherein the first arm includes a first end connected to the protective bumper body, a second end detachably connected to the protective bumper body, and a first connecting arm connected with the first end and the second end, a second arm positioned on a second side of the protective bumper body, wherein the second arm includes a third end connected to the protective bumper body, a fourth end detachably connected to the protective bumper body, and a second connecting arm connected with the third end and the fourth end.

### CROSS-REFERENCE TO RELATED APPLICATIONS

This patent application claims the benefit under 35 U.S.C. § 119(a) of Chinese Patent Application No. 201830323975.7, filed Jun. 22, 2018, which application is incorporated herein by reference.

### FIELD OF THE INVENTION

The invention broadly relates to the protective case field, more specifically to a mobile terminal protective case with a bumper, and even more particularly to a mobile terminal protective case with a bumper and detachable arms.

### BACKGROUND OF THE INVENTION

As can be derived from the variety of devices and methods directed at mobile terminal protective cases, many means have been contemplated to accomplish the desired end, i.e., protecting digital products. With the advancement in the economy, progress of society, and the improvement of the quality of life, the public's pursuit of material products is getting higher and higher. Various electronic products such as mobile phones and tablet accessories are indispensable entertainment items in people's leisure life.

However, mobile terminals such as tablets and mobile phones fall easily and are extremely fragile. A tablet is large in size and oftentimes needs to be held by both hands of the user when being viewed. As a result, the user's hands are restricted during operation and viewing of the tablet. Moreover, the tablet is more apt to slip out of the user's hands and break. The tablet itself is not convenient to position or hang from the car when driving. Thus, there is a long-felt need for a protective case to hold a tablet during operation, especially in a vehicle.

### BRIEF SUMMARY OF THE INVENTION

The present invention broadly includes a mobile terminal protection bumper, aiming to solve the problem that the arms of an existing protective bumper is not equipped for a user to both hold the protective bumper arms and hang the protective bumper from an object.

A mobile terminal protective bumper including a protective bumper body, a first arm and a second arm, and a capacitive groove for a mobile terminal is arranged on the main body of the protective bumper. The first arm is located on one side of the protection bumper body, and the first arm includes the first end part connected with the main body of the protection bumper. The second end of the detachable connection with the protection bumper body and the first connecting arm of the first end part with the second end; the second arm is arranged on the other side of the protection bumper body, and the second arm includes the third end part connected with the main body of the protection bumper. A fourth end portion detachably connected to the main body of the protective bumper and a second connecting arm body connecting the third end portion and the fourth end portion.

Further, the first portable arm and the second portable arm are both integrally formed of soft rubber.

Further, a first through hole for the fourth end card connection is provided on the second end, and/or the fourth end is provided with a second through hole for the second end clamping connection.

Furthermore, the main body of the protective bumper is provided with a first fixing groove whose shape is matched with the shape of the second end for embedding the second end, and a second fixing groove whose shape is matched with the shape of the fourth end for embedding the fourth end.

Further, both ends of the bottom of the protective bumper main body are respectively provided with a first support base and a second support base, the first fixing groove is formed on the bottom surface of the first support base, and the second fixing groove is formed on the bottom surface of the second support base.

Furthermore, the second end is in the shape of a palm, which comprises a first palm connected with the first connecting arm body and a plurality of first finger parts protruding on the side of the first palm, wherein the first through hole penetrates through the first palm.

The fourth end portion is in the shape of a palm, the fourth end portion includes a second palm portions connected to the second connecting arm body and a plurality of second finger portions protruding from the side portion of the second palm portion.

Furthermore, the groove bottom of the first fixing groove is convexly provided with a first fixing convex part, the groove bottom of the second fixing groove is convexly provided with a second fixing convex part, the shape of the first fixing convex part is matched with the shape of the first through hole, and the shape of the second fixing convex part is matched with the shape of the second through hole.

Further, the first end portion and the third end portion are detachably connected to both sides of the protective bumper body, respectively.

Furthermore, the protective bumper main body comprises two first locking grooves and a second locking groove which are respectively arranged at two sides of the protective bumper main body, wherein the maximum width of the first end part is larger than the aperture of the opening of the first locking groove, the maximum width of the third end part is larger than the aperture of the opening of the second locking groove, the first hand-held arm further includes a first stop part arranged between the first end part and the first connecting arm body, and the second hand-held arm further includes a second stop part arranged between the third end part and the second connecting arm body.

Further, the mobile terminal protective bumper further includes two hand-held arms respectively arranged at two sides of the protective bumper main body, the two ends of each second hand-held arm are respectively fixedly connected with the side part of the protective bumper main body, and one of the two hand-held arms is positioned in the space formed by enclosing the first hand-held arm and the protective bumper main body, and the other is positioned in the space formed by enclosing the second hand-held arm and the protective bumper main body.

The mobile terminal protective bumper also includes a fourth arm arranged on the top of the protective bumper main body.

Compared with the existing technology, the beneficial effect of the utility model is that the mobile terminal protective bumper comprises a first and a second arm arranged on both sides of the main body of the protective bumper, the second end of the first arm can be detachably connected with the main body of the protective bumper, and the fourth end of the second arm can be detachably connected with the main body of the protective bumper and used for the detachable connection with the second end, so that the first end the first handheld arm and the second handheld arm can be grasped by both hands to fix the mobile terminal protective bumper respectively. The second end and the fourth end can be removed from the main body of the protective bumper respectively, and the two ends can be clamped together to hang the mobile terminal protective bumper on the vehicle or other hooks.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a front structural view of the protective case with arms;

FIG. 2 is a schematic view of the first hand arm and the second hand arm in FIG. 1;

FIG. 3 is a bottom view of the protective case with arms;

FIG. 4 is a perspective view of protective case without the arms;

FIG. 5 is a rear view of the protective case with arms;

FIG. 6 is a rear view of the protective case with arms with a stand in an open position;

FIG. 7 is a perspective view of the stand reference in FIG. 6; and

FIG. 8 is a front perspective view of the protective case with arms hanging from a vehicle head rest.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “mobile terminal” is synonymous with terms such as “tablet”, “IPAD”, “smartphone”, etc., and such terms may be used interchangeably as appearing in the specification and claims. Although any methods, devices or materials similar or equivalent to those described herein can be used in the practice or testing of the invention, the preferred methods, devices, and materials are now described.

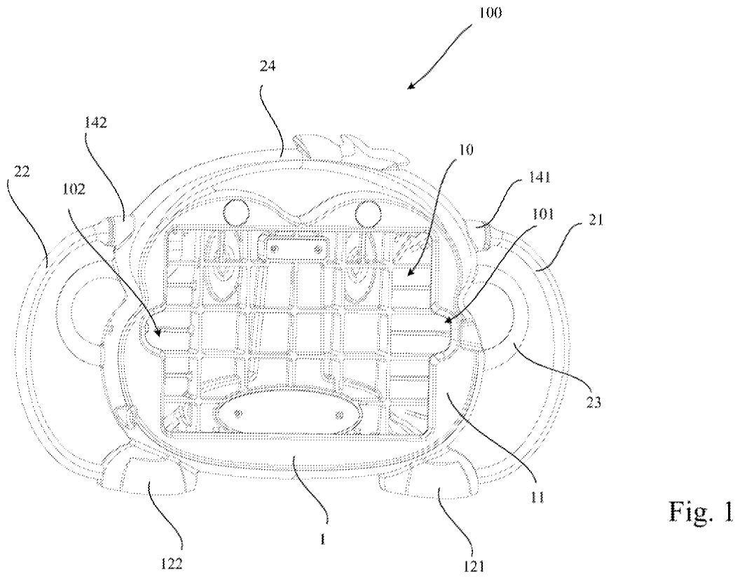

Adverting now to the figures, FIGS. 1-4 illustrate a mobile terminal protective bumper 100, including a protective bumper body 1, a first arm 21, and a second arm 22. A holding slot 10 for a mobile terminal is provided on the protective bumper body 1.

The first arm 21 is located on one side of the protective bumper body 1. The first arm 21 includes a first end 211 connected to the protective bumper body 1 and a detachable second end 212 removably connected with the protective bumper body 1. The first connecting arm 213 connects the first end 211 and the second end 212.

The second arm 22 is located on the opposite side of the protective bumper body 1. The second arm 22 includes a third end 221 connected to the protective bumper body 1 and a detachable fourth end 222 removably connected with the protective bumper body 1. The second connecting arm 223 connects the third end 221 and the fourth end 222.

When using the mobile terminal protective bumper 100, the mobile terminal, such as tablet computer, is placed into holding slot 10. The edge of holding slot 10 is coated with a soft film to prevent the mobile terminal from falling out of the holding slot 10.

The second end 212 and the fourth end 222 are respectively connected to the protective bumper body 1. In this configuration, the user holds the first arm 21 and the second arm 22 with their hands when operating the mobile terminal inside the mobile terminal protective bumper 100.

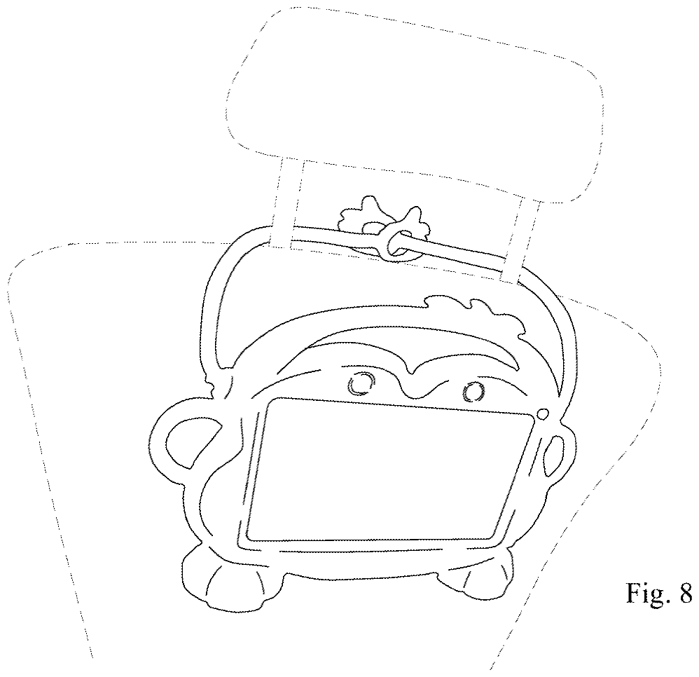

An alternative configuration allows the user to hang the mobile terminal protective bumper 100 from the headrest of a vehicle. To set up this configuration, the second end 212 and the fourth end 222 are removed from the protective bumper body 1. Once removed, the second end 212 and the fourth end 222 are removably connected around the headrest to allow the tablet in the mobile terminal protective bumper 100 to hang from the vehicle headrest, as shown in FIG. 8. The first arm 21 and the second arm 22 are connected to form a suspension arm. The suspension arm, joined first arm 21 and second arm 22, is rotated over the protective bumper main body 1. The first arm 21 and second arm 22 can be joined before being hung from the vehicle headrest, or the first arm 21 and second arm 22 can be routed around the vehicle headrest and then joined.

The first end 211 and the third end 221 are rotatably connected with the protective bumper body 1 respectively, so that the first arm 21 and the second arm 22 rotate relative to protective bumper body 1 for either an attached, hand held configuration or, detached, rotated and connected around a vehicle headrest or other object in a vehicle.

In an exemplary embodiment, rotating axles are included on both sides of the first end 211 and the second end 212 respectively, with a rotating hole extending outward and connected to the protective bumper main body 1 to realize a rotational connection between the first portable arm 21 and the second portable arm 22 and the protective bumper main body 1.

The mobile terminal protective bumper is used for a variety of electronic devices, such as smart phones, tablets, game consoles, and the like.

Preferably, referring to FIG. 1, the corresponding keys on the soft film shield and the indicator lamp are respectively provided with the first avoidance hole 101 and second avoidance hole 102.

The second end 212 and the fourth end 222 can be connected by magnetic suction connection, bonding connection, snap connection, or by tying the second end 212 with fourth end 222.

In an exemplary embodiment, as shown in FIG. 1, the first arm 21 and the second arm 22 are symmetrically arranged on the left and right sides of the protective bumper body 1.

In another exemplary embodiment, both the first arm 21 and the second arm 22 are constructed with a soft rubber body. After the first end 211 and the third end 221 are respectively connected to the protective bumper main body 1, the first arm 21 and the second arm 22, relying on its own characteristics (e.g. size and dimensioning), can be rotated relative to the protective bumper body 1.

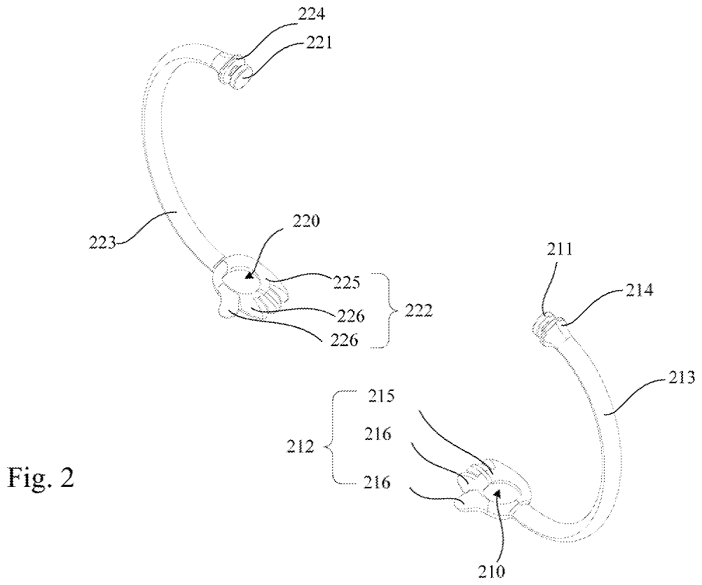

Preferably, referring to FIG. 2, the second end 212 includes a first through hole 210 for the fourth end 222 to be inserted and connected, and/or vice versa, the fourth end 222 includes a second through hole 220 for the second end to be inserted and connected. The second end 212 and the fourth end 222 are preferably soft rubber. When the second end 212 includes the first through hole 210, the fourth end 222 is folded through the first through hole 210. After the fourth end 222 passes through the first through hole 210, the first and second arms 21, 22 are linked and take their natural shape when hung from an object, e.g. a vehicle head rest.

Similarly, if the fourth end 222 includes the second through hole 220, the second end 212 is folded through the second through hole 220, after the second end 212 passes through the second through hole 220. After the second end 212 passes through the second through hole 220, the first and second arms 21, 22 are linked and take their natural shape when hung from an object, e.g. a vehicle head rest.

If the second end 212 is opened with the first through hole 210 and the fourth end portion 222 is opened with the second through hole 220, there are two options, and the second end 212 can be arbitrarily passed through the second through hole 220 or the fourth end 222 can be passed through the first through hole 210. Preferably, the maximum width of the second end 212 is larger than the width of the first connecting arm 213, and the maximum width of the fourth end portion 222 is larger than the width of the second connecting arm 223.

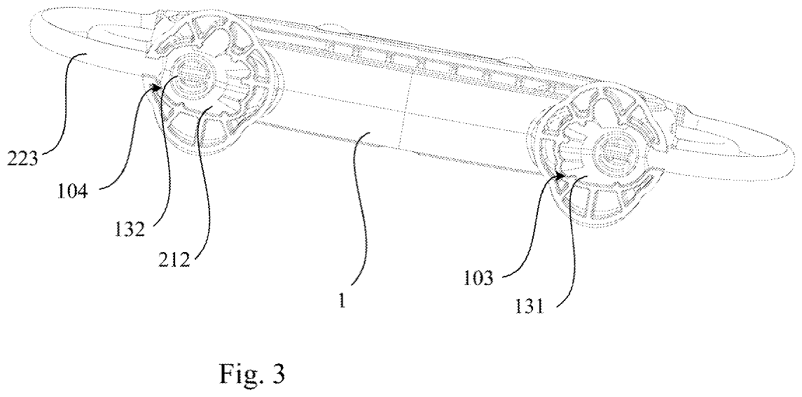

Preferably, referring to FIG. 3, the bottom of the protective bumper body 1 includes a first fixing groove 103 that accepts the shape of the second end 212. In addition, the bottom of the protective bumper body 1 includes a second fixing groove 104 that accepts the shape of the fourth end 222.

Preferably, referring to FIG. 3, the bottom two portions of the protective bumper body 1 are provided with a first support base 121 and a second support 122. The first fixing groove 103 is configured on the bottom of the first support base 121 and the second fixing groove 104 is configured on the bottom of the second support base 122.

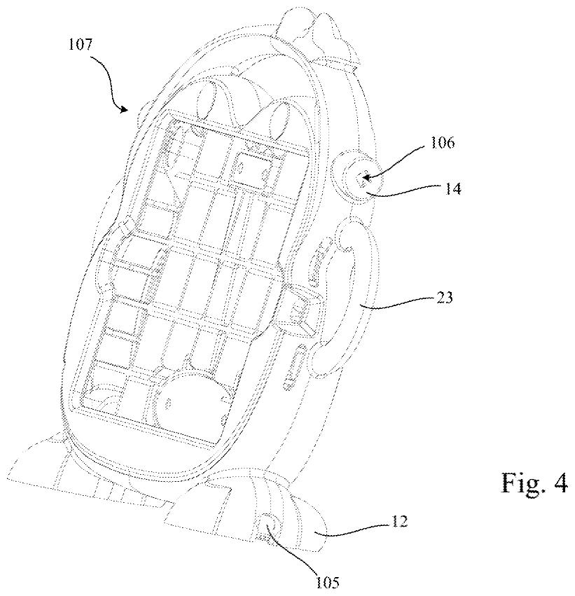

The first support base 121 and the second support base 122 support the protective bumper body 1 and permit the mobile terminal protective bumper 100 to be placed vertically on a desktop. As shown in FIG. 4, the first support base hole 105 is configured with an open path to connect with the first fixing groove 103. This permits the first connecting arm 213 to pass through first support base hole 105 allow the second end 212 to be secured to the first fixing groove 103 in the first support base 121. Similarly, the second connecting arm 223 can pass through second support base hole to allow the fourth end 222 to be secured to the second fixing groove 104 in the second support base 122.

Preferably, referring to FIGS. 2 and 3, the second end 212 is a hand palm shape, and includes a first palm portion 215 connected to the first connecting arm 213 and a plurality of first finger portions 216 protruding from the side portions of the first palm portion 215. The finger portions 216 and the first through hole 210 are positioned on the first palm portion 215. Similarly, the fourth end 222 is in a hand palm shape, and the fourth end portion 222 includes a second palm portion 225 connected to the second connecting arm body 223. The second palm portion 225 includes a plurality of second finger portions 226 protruding from the side portions of the second palm portion 225. The palm-like shape of the second end 212 and the fourth end 222 is such that the two ends are more closely embedded with the first fixing groove 103 and the second fixing groove 104, respectively.

Preferably, a first fixing protrusion 131 protrudes from the bottom of the first fixing groove 103, and a second fixing protrusion 132 protrudes from the bottom of the second fixing groove 104. The outer shape of the first fixing protrusion 131 is adapted to the shape of the first through hole 210, and the outer shape of the second fixing protrusion 132 is adapted to the shape of the second through hole 220. The second end portion 212 is embedded in the first fixing groove 103. At the same time, the first fixing protrusion 131 is embedded in the first through hole 210, so that the second end 212 is further secured within the first fixing groove 103. Similarly, the fourth end 222 is embedded in the second fixing groove 104. At the same time, the second fixing protrusion 132 is embedded in the second through hole 220, so that the fourth end 222 is further secured within the second fixing groove 104.

Preferably, the first end 211 and the third end 221 are respectively detachably connected to both side portions of the protective bumper body 1. This allows the first arm 21 and the second arm 22 to be easily replaced if they become damaged or worn from extended use.

Referring to FIG. 4, the protective bumper body 1 includes a first locking groove 106 and a second locking groove 107 respectively formed on the two sides of the protective bumper body 1. The maximum width of the first end 211 is larger than the diameter of the opening of the first locking groove 106. The maximum width of the third end 221 is larger than the diameter of the opening of the second locking groove 107. The first arm 21 further includes the first stop portion 214 disposed between the first end 211 and the first connecting arm 213. The second arm 22 further includes a second stop portion 224 disposed between the third end 221 and the second connecting arm 223.

In an exemplary embodiment, the first end 211 and the third end 221 include soft glue that is squeezed into the first lock groove 106 and the second lock groove 107, respectively, so that the first arm 21 and the second arm 22 can be detachably connected with the protective bumper body 1. The first end 211 and the third end 221 can also rotate within the first lock groove 106 and the second lock groove 107, respectively, to allow the first arm 21 and the second arm 22 to rotate relative to the main body 1 of the protective bumper. Setting the depth of the first stop portion 214 and the second stop portion 224 will set the first end 211 and the third end part 221.

Preferably, the first end portion 211 and the third end portion 221 are each cylindrical.

Preferably, the first mounting protrusion 141 and the second mounting protrusion 142 are respectively protruded from the two sides of the protective bumper body 1. The first locking groove 106 is opened on the first mounting protrusion 141, and the second locking groove 107 is opened on the second mounting protrusion 142.

Preferably, the mobile terminal protective bumper 100 further includes two fixed arms 23 respectively disposed on two sides of the protective bumper body 1, and two ends of each of the second arms 22 are respectively fixed to the side portions of the protective bumper body 1 and one of the two fixed arms 23 is located within a range formed by the first arm 21 and the protective bumper body 1, and the other is located within a range formed by the second arm 22 and the protective bumper body 1. Alternatively, the mobile terminal protection cover 100 further includes an upper fixed arm 24 disposed on the top of the protective bumper body 1.

The size of the two fixed arms 23 is smaller than the size of the first arm 21 and the size of the second arm 22. The protective bumper body can be held using fixed arms 23, which are sized to be held by the hands of a child. The upper fixed arm 24 at the top of the protective bumper can also be held by one hand.

Preferably, the first arm 21 and the second arm 22 are all curved, and the central angles of the first arm 21 and the second arm 22 are all in the range of 60°-150° (degrees). The third fixed arm 23 is also curved, and the central angle of the third fixed arm 23 is preferably 180°-300° (degrees).

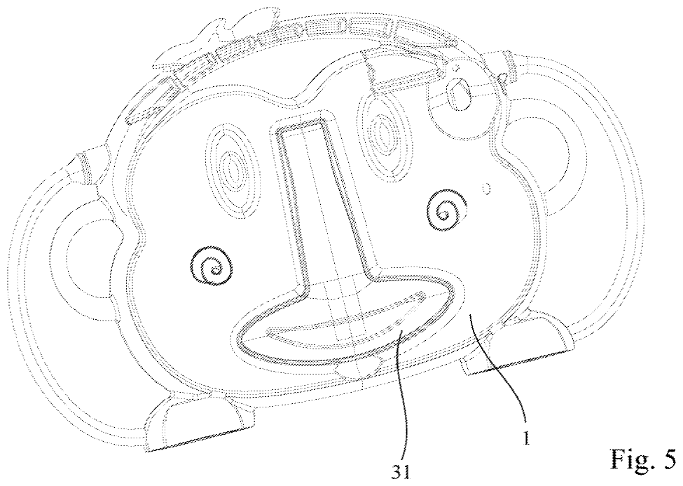

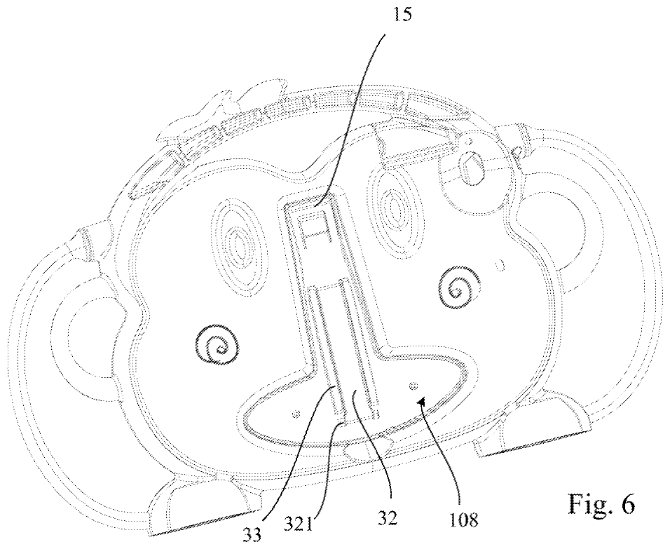

Preferably, referring to FIGS. 5 and 6, the protective bumper body 1 includes a first end surface and a second end surface disposed opposite to each other, the containing groove 10 is defined on the first end surface, and the mounting groove 108 is opened on the second end surface. The mobile terminal protective bumper 100 further includes a support 31 disposed in the mounting groove 108. One end of the support 31 is rotatably connected to the slot arm of the mounting groove 108.

When in use, the bottom of the support part 31 is pulled away from the mounting groove 108, and the support part 31 is supported on a desk or other supporting surface, so the protective bumper body 1 can be more firmly set at an angle. The groove bottom of the installation groove 108 is connected with the connection plate 32. One end of the connection plate 32 slidably connects with the groove bottom, the other end rotates with the inner side of the support 31. When the support 31 is opened, one end of the connection plate 32 slides relative to the groove bottom of the mounting groove 108, and the other end gradually moves away from the groove bottom of the mounting groove 108 with the support 31. When the support 31 supports the main body of the protection bumper 1, the connecting plate 32 can be used for the support 31. The connection plate 32 can also avoid excessive opening of the support 31 relative to the main body 1 of the protective bumper.

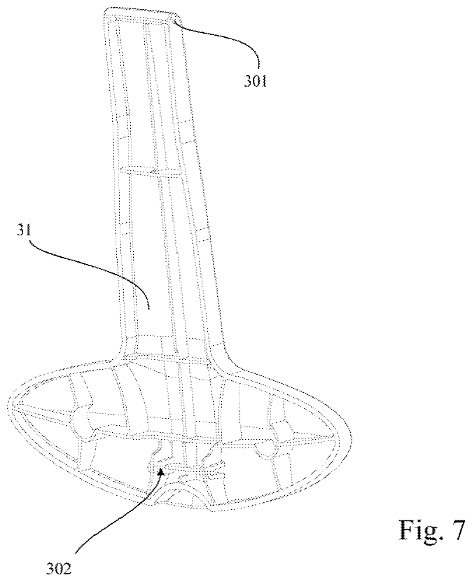

Preferably, referring to FIGS. 6 and 7, the groove bottom of the mounting groove 108 is provided with a first rotating shaft 15 for matching with the first rotating hole 301 opened on the support 31 to rotate the support 31 to the groove bottom of the installation groove 108. A slide rail 33 is arranged on the groove bottom of the mounting groove 108 for sliding at one end of the connection plate 32. The other end of the connecting plate 32 is provided with a second rotating shaft 321 for rotating the connection of the second rotating hole 302 provided on the support 31.

As used herein, the term protective sleeve can mean any type of case or container to cover a digital product.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A protective case for digital products, comprising:
a protective bumper body, wherein the protective bumper body comprises a holding slot for receiving a mobile terminal;
a first arm positioned on a first side of the protective bumper body, wherein the first arm comprises:
a first end connected to the protective bumper body;
a second end detachably connected to the protective bumper body; and
a first connecting arm connected with the first end and the second end;
a second arm positioned on a second side of the protective bumper body, wherein the second arm comprises:
a third end connected to the protective bumper body;
a fourth end detachably connected to the protective bumper body; and
a second connecting arm connected with the third end and the fourth end.

2. The protective case for digital products as recited in claim 1, wherein the first arm and the second arm are both integrally formed of a soft rubber.

3. The protective case for digital products as recited in claim 2, wherein the second end comprises a first through hole for the fourth end portion to be inserted and connected, and/or the fourth end comprises a second through hole for the second end portion to be inserted and connected.

4. The protective case for digital products as recited in claim 3, wherein the protective bumper body comprises a first fixing groove with a shape adapted to complement the outer shape of the second end, and a second fixing groove with a shape adapted to complement the outer shape of the fourth end.

5. The protective case for digital products as recited in claim 4, wherein:
the bottom of the protective bumper body comprise a first support base and a second support base;
the first fixing groove is positioned in the bottom surface of the first support base; and
the second fixing groove is positioned in the bottom surface of the second support base.

6. The protective case for digital products as recited in claim 4, wherein:
the second end has a hand shape and comprises:
a first palm portion connected to the first connecting arm;
a plurality of first finger portions protruding from a side portion of the first palm portion;
and a first through hole on the first palm portion; and/or,
the fourth end portion has a hand shape and comprises:
a second palm portion connected to the second arm; and
a plurality of second finger portions protruding from a side portion of the second palm portion.

7. The protective case for digital products as recited in claim 4, wherein:
the first fixing groove has a convex shape that protrudes outward from the bottom of the first fixing groove;
the second fixing groove has a convex shape that protrudes outward from the bottom of the second fixing groove;
the convex shape of the first fixed groove complements the shape of the first through hole; and
the convex shape of the second fixed groove complements the shape of the second through hole.

8. The protective case for digital products as recited in claim 1, wherein the first end and the third end are detachably connected to the sides of the protective bumper body.

9. The protective case for digital products as recited in claim 7, wherein:
the protective bumper body comprises a first locking groove and a second locking groove that are respectively arranged at two sides of the protective bumper main body, the maximum width of the first end part is larger than the aperture of the opening of the first locking groove, the maximum width of the third end part is larger than the aperture of the opening of the second locking groove;
the first arm further comprises a first stop part arranged between the first end part and the first connecting arm body, and the second arm further comprises a second stop part arranged between the third end part and the second connecting arm body.

10. The protective case for digital products as recited in claim 1, wherein the mobile terminal protective bumper further comprises two fixed arms respectively arranged on two sides of the protective bumper body, the two ends of each second fixed arm are respectively fixedly connected with the side part of the protective bumper body, and one of the two fixed arms is located in the range formed by enclosing the first hand-held arm and the protective bumper main body, and the other is located in the range formed by enclosing the second fixed arm and the protective bumper body.

11. The protective case for digital products as recited in claim 10, wherein the mobile terminal protective bumper comprises a fourth fixed arm arranged on the top of the protective bumper main body.

12. A protective case for digital products, comprising:
a protective bumper body, wherein the protective bumper body comprises a holding slot for receiving a mobile terminal;
a first arm connected to the protective bumper body, wherein:
a first end of the first arm is rotatably connected to the protective bumper body; and
a second end of the first arm is removably connected to the protective bumper body:
a third arm connected to the protective bumper body, wherein:
a third end of the third arm is rotatably connected to the protective bumper body; and
a fourth end of the third arm is removably connected to the protective bumper body; and
removably connecting the second end and the fourth end to each other to allow the protective bumper body to be hung from an object.

13. The protective case for digital products as recited in claim 12, further comprising a first through hole in the second end and a second through hole in the fourth end, wherein the second end and the fourth end are removably connected to each other through the first through hole or the second through hole.

14. A method for holding digital products, comprising:
dis-engaging a second end from a protective bumper body;
dis-engaging a fourth end from a protective bumper body;
rotating the disengaged second end and fourth end; and
removably connecting the second end and the fourth end together, either by routing the fourth end within a first through hole in the second end, or by routing the second end within a second through hole in the fourth end.

15. The method of holding digital products as recited in claim 14, wherein the second end and the fourth end are removably connected around a vehicle headrest.
